(19) United States
(12) Patent Application Publication
(10) Pub. No.: US 2011/0099626 A1
(43) Pub. Date: Apr. 28, 2011

(54) MULTI-FUNCTIONAL PERIPHERAL CONTROL SYSTEM AND MULTI-FUNCTIONAL PERIPHERAL

(75) Inventor: Kunihiko TSUJIMOTO, Osaka (JP)

(73) Assignee: SHARP KABUSHIKI KAISHA, Osaka (JP)

(21) Appl. No.: 12/913,306

(22) Filed: Oct. 27, 2010

(30) Foreign Application Priority Data
Oct. 27, 2009 (JP) 2009-246065

(51) Int. Cl. G06F 21/00

(52) U.S. Cl. 726/18

(57) ABSTRACT

A multi-functional peripheral control system is composed of an authentication server having a user information management database for storing authentication information corresponding to each user, and that performs user authentication processing with reference to the user information management database, and one or more multi-functional peripherals managed by the authentication server, in which the multi-functional peripheral has a user information management table for storing authentication information corresponding to a user, when being possible to connect to the authentication server, transmits user information to the authentication server to perform authentication processing, and when being impossible to connect to the authentication server, performs alternate authentication with reference to the user information management table, and the multi-functional peripheral includes a user deletion portion for deleting user information that authentication is not permitted by the authentication server from the user information management table.

### CROSS-NOTING PARAGRAPH

This non-provisional application claims priority under 35 U.S.C. §119(a) on Patent Application No. 2009-246065 filed in JAPAN on Oct. 27, 2009, the entire contents of which are hereby incorporated herein by reference.

### FIELD OF THE INVENTION

The present invention relates to a multi-functional peripheral control system and a multi-functional peripheral that perform authentication processing with an authentication server connected to a network, and when it is impossible to connect to the authentication server, perform alternate authentication inside the multi-functional peripheral.

### BACKGROUND OF THE INVENTION

In an environment in which a user selects any one from among a plurality of multi-functional peripherals to be able to perform a copy, printing, facsimile transmission, or the like, in the case of performing authentication, authorization restriction, limitation of the number of output sheets, charge management and the like for each user, the plurality of multi-functional peripherals and an authentication server are connected to a network so that the above-described management is managed in an integrated manner with the authentication server.

However, in the case where authentication is not able to be performed due to an authentication server crash, network failure or the like, the user is not able to use the multi-functional peripheral.

Therefore, in an authentication system described in Japanese Laid-Open Patent Publication No. 2006-092018, an alternate authentication portion is included in a multi-functional peripheral, an authentication result of being successfully authenticated by the authentication server is recorded in the multi-functional peripheral, and when connection to the authentication server is not able to be established due to network failure or the like, authentication is performed by the alternate authentication portion using the recorded authentication result, so that a user is able to use the multi-functional peripheral.

In the case of the authentication system described in the above-described Japanese Laid-Open Patent Publication No. 2006-092018, a user who is permitted to be authenticated by the alternate authentication portion is a user who has used a multi-functional peripheral incorporating the alternate authentication portion among users managed by the authentication server. That is, automatically registering user information successfully authenticated by the authentication server as a user who uses in the alternate authentication portion is synonymous therewith.

In such an authentication system, there is a problem that even when the user managed by the authentication server is deleted, authentication information of the user remains inside the multi-functional peripheral, therefore, when switching to the alternate authentication portion due to network failure or the like, a user who should not be given permission for use under normal circumstances is authenticated and thus is able to use the multi-functional peripheral.

### SUMMARY OF THE INVENTION

An object of the present invention is to provide a multi-functional peripheral control system including a multi-functional peripheral enabled to perform appropriate authentication processing similarly to an authentication server even when authentication is performed by an alternate authentication portion.

The multi-functional peripheral control system of the present invention is configured as follows.

(1) The multi-functional peripheral control system composed of an authentication server which has a user information management database for storing authentication information corresponding to each user and performs user authentication processing with reference to the user information management database, and one or more multi-functional peripherals managed by the authentication server, wherein the multi-functional peripheral has a user information management table for storing authentication information corresponding to a user, when being possible to connect to the authentication server, transmits user information to the authentication server to perform authentication processing, and when being impossible to connect to the authentication server, performs alternate authentication with reference to the user information management table, and the multi-functional peripheral includes a user deletion portion for deleting user information that is not permitted to be authenticated by the authentication server from the user information management table.

(2) Further, in the case of performing the alternate authentication in the multi-functional peripheral of the above-described (1), when connection to an authentication server is restored, a job processing result completed by the alternate authentication is transmitted to the authentication server, and when receiving a notification that user authentication information according to the job processing result is not permitted to be authenticated by the authentication server, the user is deleted from the user information management table.

(3) Additionally, in the multi-functional peripheral control system of the above-described (1) or (2), when registration/deletion of a user in a user information management table of the multi-functional peripheral or a user information management database of the authentication server is performed by an administrator, a notification of registration/deletion of the user is transmitted from the multi-functional peripheral to the authentication server or transmitted from the authentication server to each multi-functional peripheral, and registration/deletion of the user is reflected in the user information management table or the user information management database to register/delete the user.

(4) Further, when the number of users to be registered in the user information management table exceeds a predetermined number, the multi-functional peripheral adjusts the number of registrations of users according to the following rules.

(a) A user whose date and time of using the multi-functional peripheral is the oldest is deleted.

(b) A user whose number of using the multi-functional peripheral is the smallest is deleted.

(c) In the above-described (a) or (b), deletion is performed from among users registered when authenticated by the authentication server.

(d) In the above-described (a), (b), or (c), when there are a plurality of users to be deleted, a user whose user identification number is the smallest is deleted.

### BRIEF DESCRIPTION OF THE DRAWINGS

FIG. 1 is a block diagram showing a schematic configuration of a multi-functional peripheral control system according to an embodiment 1 of the present invention;

FIG. 2A is a user information management table in a multi-functional peripheral, and FIG. 2B is an example of a data structure of a user information management database in an authentication server;

FIG. 3 is a flowchart describing a processing procedure of registration and deletion of a user at the time of external authentication;

FIG. 4 is a block diagram showing a schematic configuration of the multi-functional peripheral control system according to an embodiment 2 of the present invention;

FIG. 5 is a flowchart describing a processing procedure at the time of recovery to the external authentication from alternate authentication;

FIG. 6 is a block diagram showing a schematic configuration of the multi-functional peripheral control system according to an embodiment 3 of the present invention;

FIG. 7 is a flowchart describing a processing procedure in the case where a user is registered/deleted by an administrator of a multi-functional peripheral; and

FIG. 8 is a flowchart describing a processing procedure in the case where a user is registered/deleted by an administrator of the authentication server.

### PREFERRED EMBODIMENTS OF THE INVENTION

Hereinafter, description will be given for embodiments of the present invention in detail with reference to diagrams.

### Embodiment 1

### Schematic Configuration of Multi-Functional Peripheral Control System

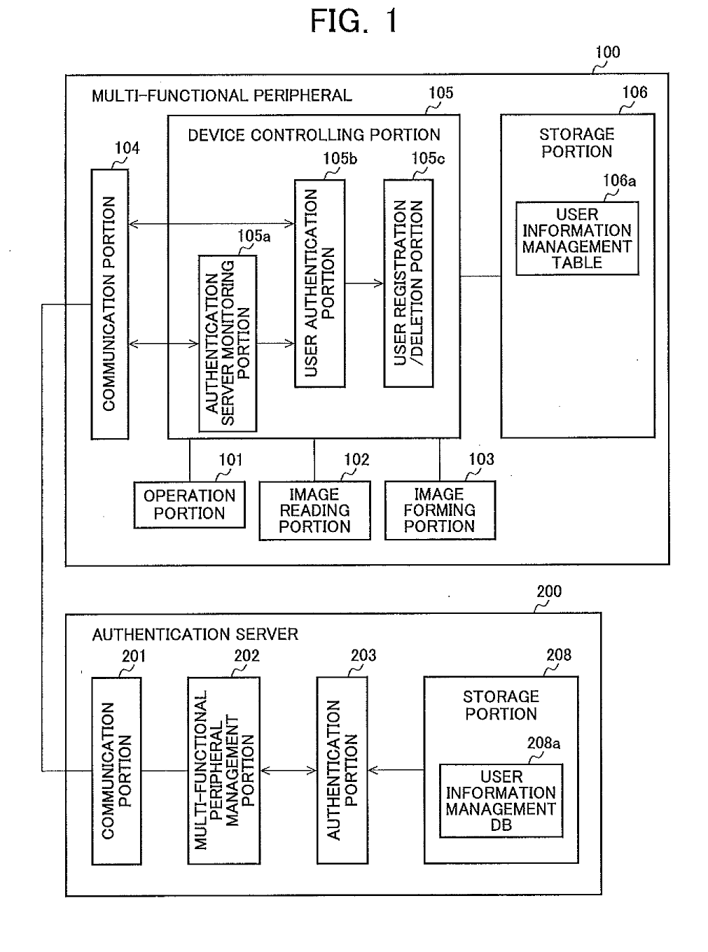

FIG. 1 is a block diagram showing a schematic configuration of a multi-functional peripheral control system according to an embodiment 1 of the present invention. In the diagram, the multi-functional peripheral control system is configured so that one or more multi-functional peripherals 100 in which a plurality of functions such as a copy function, a scanner function, a facsimile function and a printer function, for example, are available is connected through a network to an authentication server 200 that performs authentication processing of a user who uses the multi-functional peripheral 100.

<Configuration of Multi-Functional Peripheral 100 in Embodiment 1>

In FIG. 1, the multi-functional peripheral 100 includes an operation portion 101, an image reading portion 102, an image forming portion 103, a communication portion 104, a device controlling portion 105 and a storage portion 106, and is controlled by the device controlling portion 105.

The operation portion 101 is composed of a plurality of operation keys for receiving operation input of a user, an LCD (Liquid Crystal Display) integrated with a touch panel and the like, and a login screen, a message and the like are displayed on the LCD.

The image reading portion 102 irradiates a document with an image irradiation lamp and a reflected light thereof is received by a CCD (Charge Coupled Device) sensor so that an image is read from the document and image data corresponding to the read image is output.

The image forming portion 103 prints on a sheet image data read at the image reading portion 102, image data that is transmitted from a client PC (personal computer) or the like by a LAN (Local Area Network) via the communication portion 104 and image data received from a facsimile apparatus or the like.

The communication portion 104 controls transmission/reception of various data to/from the authentication server 200, a client PC, a facsimile apparatus and the like that are connected through a LAN with use of a network interface or the like.

The device controlling portion 105 includes a CPU (Central Processing Unit), a RAM (Random Access Memory), a ROM (Read Only Memory) and the like, and reads various control programs and setting information from the storage portion 106 to realize functions provided in the multi-functional peripheral 100.

The device controlling portion 105 of the present embodiment 1 includes an authentication server monitoring portion 105a, a user authentication portion 105b, and a user registration/deletion portion 105c.

The storage portion 106 stores various control programs of the multi-functional peripheral 100, fixed information that is used for the various control programs, setting information set by a user at the time of use of the multi-functional peripheral, state information in an execution state of the multi-functional peripheral, image data subjected to image processing in the image reading portion 102 and the image forming portion 103, or the like.

Additionally, the storage portion 106 is also used for storing a user information management table 106a that is used for authentication by the multi-functional peripheral 100 itself.

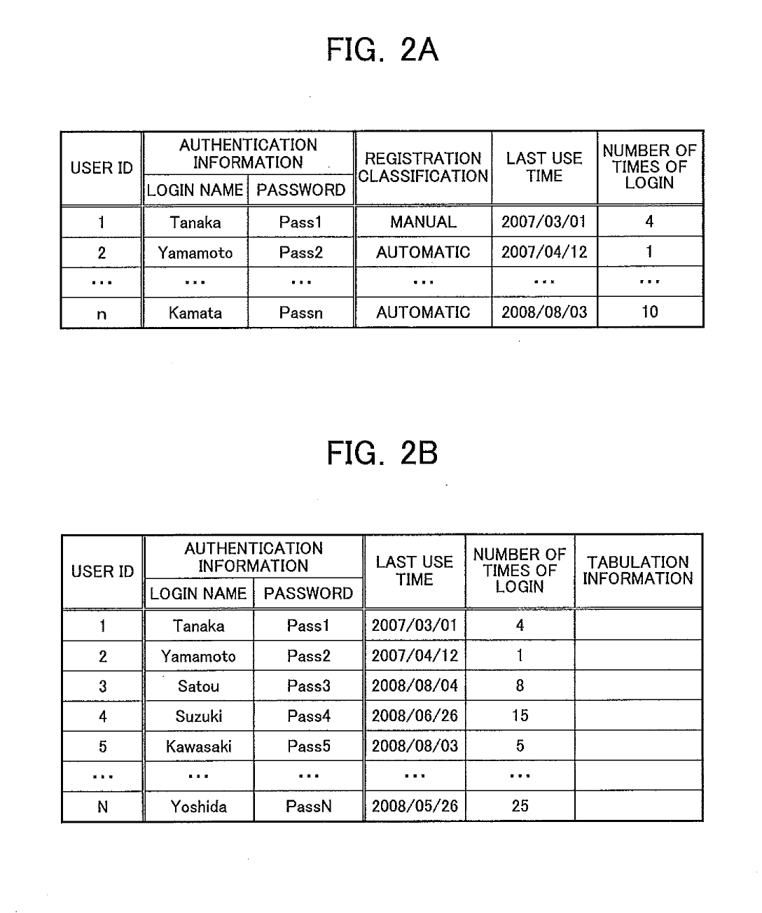

The user information management table 106a is composed of data items for each user as illustrated in FIG. 2A, and stores at least an identifier for identifying a user (user ID) and authentication information (login name and password) for authenticating the user that are associated with each other.

<Monitoring Connection to Authentication Server 200>

In the present embodiment 1, the authentication server monitoring portion 105a monitors whether or not it is possible to connect to the authentication server 200 in order to determine whether to perform authentication processing at the authentication server 200 or to perform authentication processing by the multi-functional peripheral 100 itself.

Note that, performing authentication processing at the authentication server 200 is referred to as performing external authentication, and performing authentication processing by the multi-functional peripheral 100 itself is referred to as performing alternate authentication.

The authentication server monitoring portion 105a monitors at a predetermined time interval whether or not it is possible to connect to the authentication server 200 that manages the multi-functional peripheral 100, transmits a “pause signal” to the user authentication portion 105b in the case of not being connectable thereto, and transmits a “connection signal” in the case of a connected state.

<User Authentication Processing>

Next, the user authentication portion 105b confirms whether or not authentication information (login name and password) input by a user from the operation portion 101 or the like is available at the multi-functional peripheral control system.

(At the Time of External Authentication)

The user authentication portion 105b, during receiving the “connection signal” from the authentication server monitoring portion 105a, transmits user authentication information (login name and password) to the authentication server 200 as a user authentication request to perform external authentication.

When “refusal of authentication permission” is returned from the authentication server 200, the user registration/deletion portion 105c deletes the user, and a message such that it is impossible to authenticate is displayed on the operation portion 101 to urge to login again.

On the other hand, when “authentication permission” and information concerning the user are returned from the authentication server 200, the user registration/deletion portion 105c registers the user or updates user information of the user, and reading and execution of a job are thereafter performed.

In the case of deleting a user, when authentication information (login name and password) of the designated user is stored in the user information management table 106a, the user registration/deletion portion 105c deletes the user from the user information management table 106a.

Further, in the case of registering a user, when authentication information (login name and password) of the designated user is not stored in the user information management table 106a, an identifier for the user (user ID) is generated, and the user ID, the user authentication information (login name and password) and information concerning the user that is returned from the authentication server 200 are associated with each other and are registered in the user information management table 106a.

On the other hand, when the user has already been registered, the user information management table 106a is updated only with the information concerning the user that is returned from the authentication server 200.

This allows the authentication server 200 and the multi-functional peripheral 100 to use the same user information.

On the other hand, “authentication permission” and the information concerning the user, in the case of being returned from the authentication server 200, are associated with the user authentication information so that the user information management table 106a is updated by being rewritten with the returned information concerning the user, and reading and execution of a job are thereafter performed.

(At the Time of Alternate Authentication)

Furthermore, while the user authentication portion 105b receives the “pause signal”, the multi-functional peripheral 100 itself refers to the user information management table 106a to determine whether user authentication information is stored, and in the case of being stored, “authentication permission” results therefrom, and reading and execution of a job are thereafter performed.

Moreover, in the case of not being stored, “refusal of authentication permission” results therefrom, and a message such that it is impossible to authenticate is displayed on the operation portion 101 to urge to login again.

<Configuration of Authentication Server 200 in Embodiment 1>

In FIG. 1, the authentication server 200 includes a communication portion 201, a multi-functional peripheral management portion 202, an authentication portion 203 and a storage portion 208, and is controlled by the multi-functional peripheral management portion 202.

The communication portion 201 controls transmission/reception of various data to/from the multi-functional peripherals 100 that are managed by the authentication server 200 connected through a LAN with use of a network interface or the like.

The multi-functional peripheral management portion 202 is provided with a CPU, a RAM, a ROM and the like, and reads various control programs and setting information from the storage portion 208 to control functions provided in the authentication server 200.

The storage portion 208 stores various control programs of the authentication server 200, fixed information that is used in the various control programs or information in an execution state of the authentication server. Further, the storage portion 208 includes a user information management database (DB) 208a for performing user authentication requested from each multi-functional peripheral 100 that is managed by the authentication server 200.

The user information management database 208a is composed of at least the same data items as those of the user information management table 106a as illustrated in FIG. 2B, and stores at least an identifier for identifying each user (user ID) and authentication information (login name and password) that are associated with each other.

<User Authentication Processing>

The multi-functional peripheral management portion 202 receives a user authentication request including user authentication information (login name and password) from the multi-functional peripheral 100 via the communication portion 201, and the authentication portion 203 executes user authentication.

When authentication information (login name and password) designated by the user authentication request is correspondingly stored in the user information management database 208a, the authentication portion 203 returns “authentication permission” and information concerning a user corresponding to the authentication information, otherwise, returns “refusal of authentication permission”.

<Processing Procedure at the Time of External Authentication in Multi-Functional Peripheral 100>

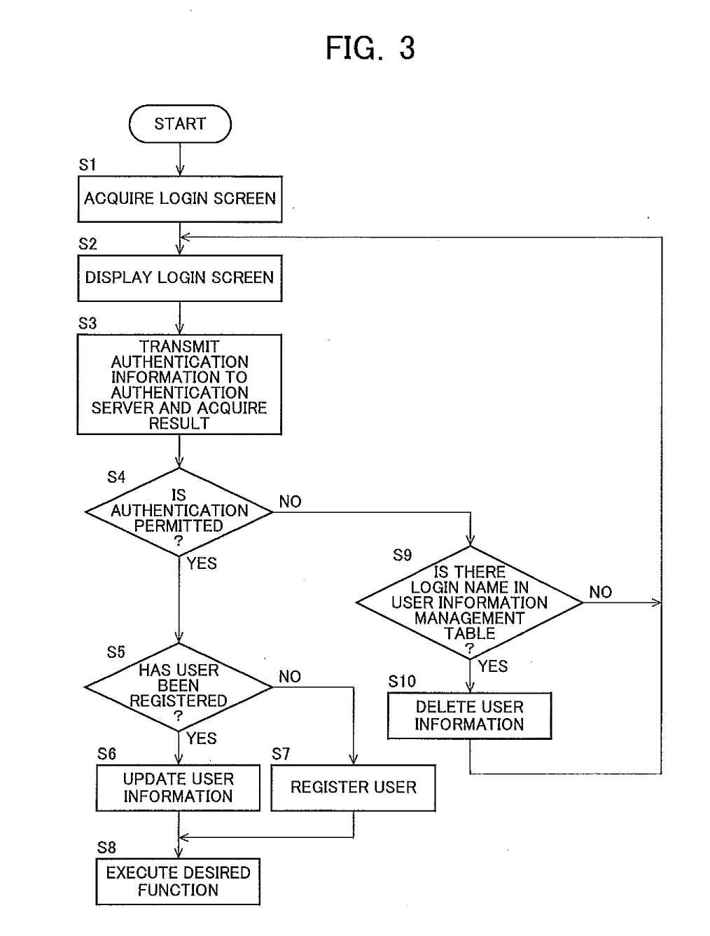

FIG. 3 is a flowchart describing a processing procedure of user registration and user deletion at the time of external authentication in the multi-functional peripheral 100.

At the time of boot of the multi-functional peripheral 100 by power-on, or at the time of termination of use of a multi-functional peripheral by a user (for example, logout), a login screen is acquired from the authentication server 200 or the multi-functional peripheral 100 (step S1), and the login screen is displayed on the operation portion 101 (step S2).

Authentication information (login name and password) input by a user on a login screen is transmitted to the authentication server 200 via the communication portion 104, and an authentication result is returned from the authentication server 200 (step S3).

This response is transmitted together with “authentication permission” and information concerning the user when authentication is permitted, and only “refusal of authentication permission” is transmitted when authentication is not permitted.

When the authentication result is “authentication permission” (YES of step S4), and authentication information of the authenticated user is stored in the user information management table 106a (YES of step S5), the user information management table 106a is updated by being rewritten with the retuned information concerning the user (step S6), and a screen for executing functions desired by a user is displayed (step S8).

On the other hand, in the case where the authenticated user is not stored in the user information management table 106a (NO of step S5), the user authentication information (login name and password) and the information concerning the user are stored in the user information management table 106a (step S7), and a screen for executing functions desired by the user is displayed (step S8).

Further, when the authentication result is “refusal of authentication permission” (NO of step S4), and the authentication information of the designated user is not stored in the user information management table 106a (NO of step S9), the flow goes back to the step S2, otherwise (YES of step S9), information related to the designated user is deleted from the user information management table 106a (step S10), the flow goes back to the step S2, and a message such that it is impossible to authenticate is displayed on the operation portion 101 to urge to login again.

The processing as described above allows the user information management table 106a of the multi-functional peripheral 100 and the user information management database 208a of the authentication server 200 to include the same content for the same user.

### Embodiment 2

In the present embodiment 2, when a user related to a job executed during alternate authentication is not registered in the user information management database 208a of the authentication server 200, the user is deleted from the user information management table 106a of the multi-functional peripheral 100 so that user information registered for the same user in the user information management database 208a and the user information management table 106a becomes the same in content.

<Configuration of Multi-Functional Peripheral 100 in Embodiment 2>

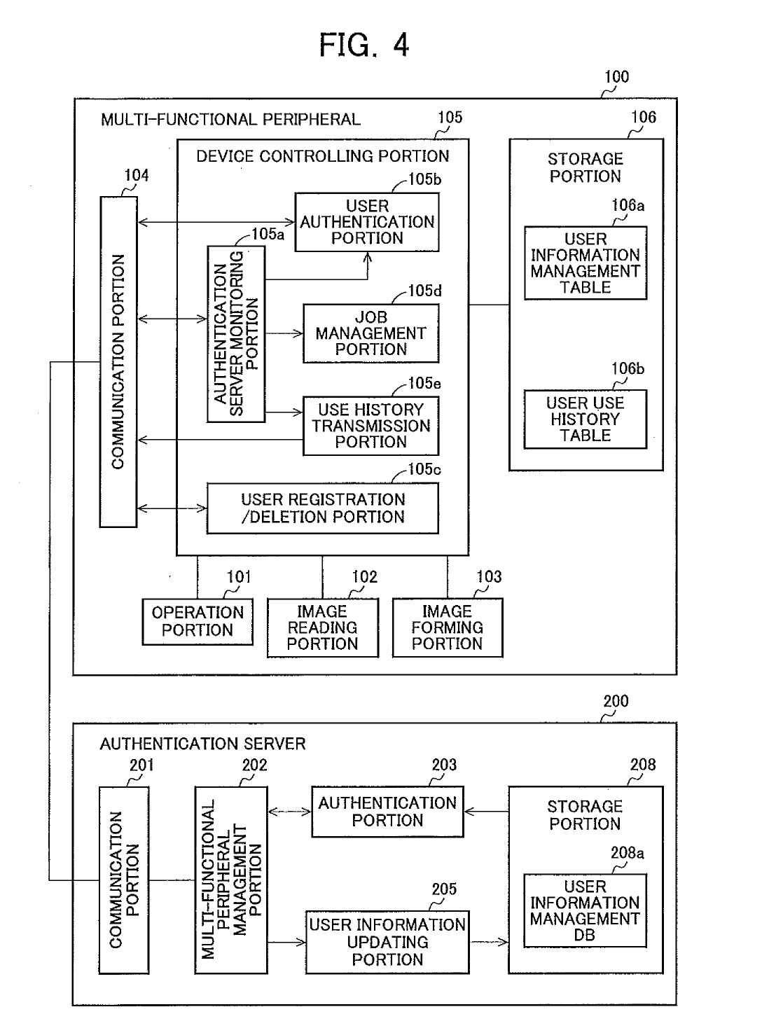

FIG. 4 is a block diagram showing a schematic configuration of the multi-functional peripheral control system according to the embodiment 2 of the present invention. In the diagram, the device controlling portion 105 includes the authentication server monitoring portion 105a, the user authentication portion 105b, a job management portion 105d, a use history transmission portion 105e and the user registration/deletion portion 105c. Additionally, the storage portion 106 includes the user information management table 106a and a user use history table 106b. The diagram includes the same components as those of the embodiment 1, however, shows only differences.

First, the authentication server monitoring portion 105a, in the case of not being connectable to the authentication server 200, transmits a “pause signal” to the user authentication portion 105b and the job management portion 105d, and transmits a “connection signal” thereto respectively in the case of a connected state.

Moreover, in the case of restoring to the state of being connectable to the authentication server 200, the “connection signal” is transmitted to the user authentication portion 105b and the job management portion 105d, and a “restoration signal” is transmitted to the use history transmission portion 105e.

<Execution Management of Job>

The job management portion 105d sequentially executes at the multi-functional peripheral 100 a job designated at the operation portion 101 or a job received from a client PC or a facsimile apparatus, and when execution of the job is finished, in the case of receiving the “pause signal” from the authentication server monitoring portion 105a, (a login name, a password, a termination time and the number of output sheets) are stored in the user use history table 106b as a user use history for the finished job.

Further, when the “connection signal” is received from the authentication server monitoring portion 105a, (a login name, a password, a termination time and the number of output sheets) are transmitted to the authentication server 200, and tabulation information that is stored in the user information management database 208a is updated with respect to the finished job.

<Transmission of User Use History Along with Recovery of Authentication Server 200>

Next, the use history transmission portion 105e, at the time of reception of a “restoration signal” from the authentication server monitoring portion 105a, transmits all user use histories that are stored in the user use history table 106b to the authentication server 200, and deletes the user use history.

Here, the user use history includes, for each job, user authentication information (login name and password) related to the job, the termination time when the job is finished and the number of output sheets output by the job, and is a job result output at the time of alternate authentication.

<User Deletion Notification from Authentication Server 200>

When a user related to the user use history transmitted from the multi-functional peripheral 100 is not registered in the user information management database 208a, the authentication server 200 transmits the user authentication information to the multi-functional peripheral 100 to delete the user from the user information management table 106a of the multi-functional peripheral 100.

When receiving the notification of authentication information (login name and password) of a user to be deleted from the authentication server 200 via the communication portion 104, the user registration/deletion portion 105c deletes a user that corresponds to the notified authentication information from the user information management table 106a in the case where the notified authentication information is correspondingly stored in the user information management table 106a.

<Configuration of Authentication Server 200 in Embodiment 2>

In FIG. 4, the authentication server 200 includes the communication portion 201, the multi-functional peripheral management portion 202, the authentication portion 203, a use history reception portion 204 and the storage portion 208. Further, the storage portion 208 includes the user information management database 208a. The diagram includes the same components as those of the embodiment 1, however, shows only differences.

<Reception of User Use History from Multi-Functional Peripheral 100>

The multi-functional peripheral management portion 202, in the case of receiving a user use history notification from the multi-functional peripheral 100 via the communication portion 201, activates the use history reception portion 204 and passes the user use history notification.

The use history reception portion 204 determines whether or not user authentication information (login name and password) related to the passed user use history notification is stored in the user information management database 208a.

When the user authentication information is not stored, a user deletion notification including the user authentication information (login name and password) is transmitted to the multi-functional peripheral 100 that transmitted the notification.

On the other hand, when the user authentication information is stored, tabulation processing is performed to update the user information management database 208a.

<Processing Procedure at the Time of Recovery to External Authentication from Alternate Authentication in Multi-Functional Peripheral 100>

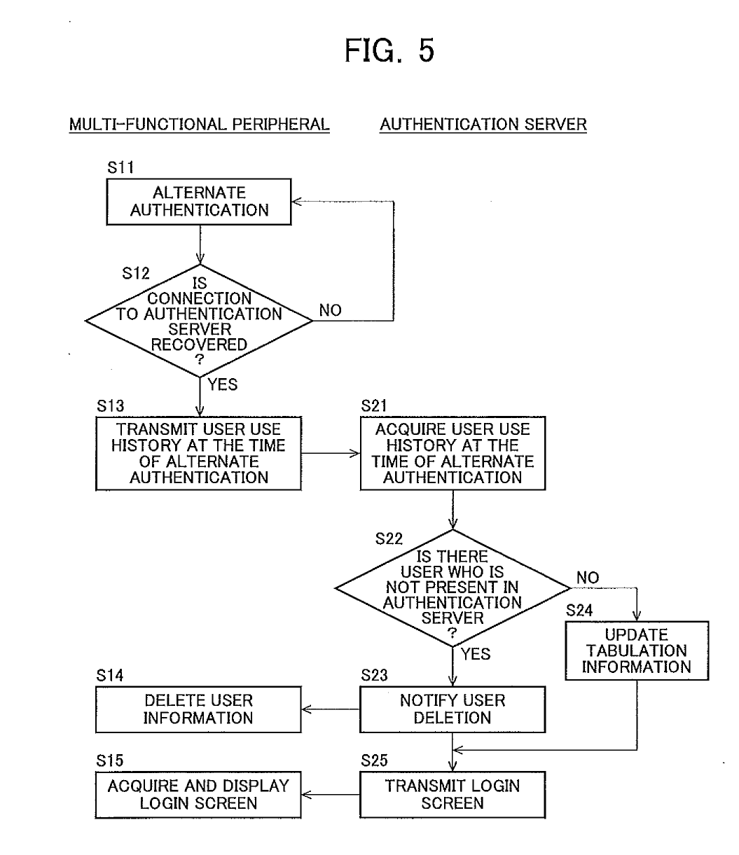

FIG. 5 is a flowchart describing a processing procedure at the time of recovery to external authentication from alternate authentication.

When the multi-functional peripheral 100 is executing alternate authentication (step S11), confirmation is made whether it is possible to connect to the authentication server 200 at a predetermined interval, and in the case of becoming a connected state (YES of step S12), connection to the authentication server 200 is performed to transmit the user use history in which execution is completed in alternate authentication to the authentication server 200 (step S13).

The authentication server 200 receives the user use history transmitted from the multi-functional peripheral 100 (step S21). Note that, the step S13 and steps S22 to S24 are repeatedly executed concerning individual user use history.

When user authentication information related to the received user use history is not registered in the user information management database 208a (YES of step S22), it is considered that a user who has already been deleted at the authentication server 200 remains in the user information management table 106a of the multi-functional peripheral 100, and a user deletion notification including the user authentication information is transmitted to the multi-functional peripheral 100 that transmitted the user use history (step S23), then the flow proceeds to step S25.

In the multi-functional peripheral 100, a user related to the received user deletion notification is deleted from the user information management table 106a (step S14).

On the other hand, in the case where user authentication information related to the received user use history is registered in the user information management database 208a (NO of step S22), tabulation information is accumulated, the user information management database 208a of the user is updated (step S24), and the flow proceeds to step S25.

When processing for all the received user use histories is finished, the authentication server 200 transmits a login screen to the multi-functional peripheral 100 (step S25), and the multi-functional peripheral 100 displays the received login screen on the operation portion 101 (step S15).

This allows a user who has already been deleted in the authentication server not to be used for alternate authentication.

### Embodiment 3

An administrator has authorization to register or delete a user who uses the multi-functional peripheral control system.

In the present embodiment 3, when the administrator updates user information for the user information management database 208a of the authentication server 200, updating of a user is notified to all multi-functional peripherals 100 under management.

Additionally, when the administrator updates user information for the user information management table 106a of the multi-functional peripheral 100, updating of a user is notified to the authentication server 200.

<Configuration of Multi-Functional Peripheral 100 in Embodiment 3>

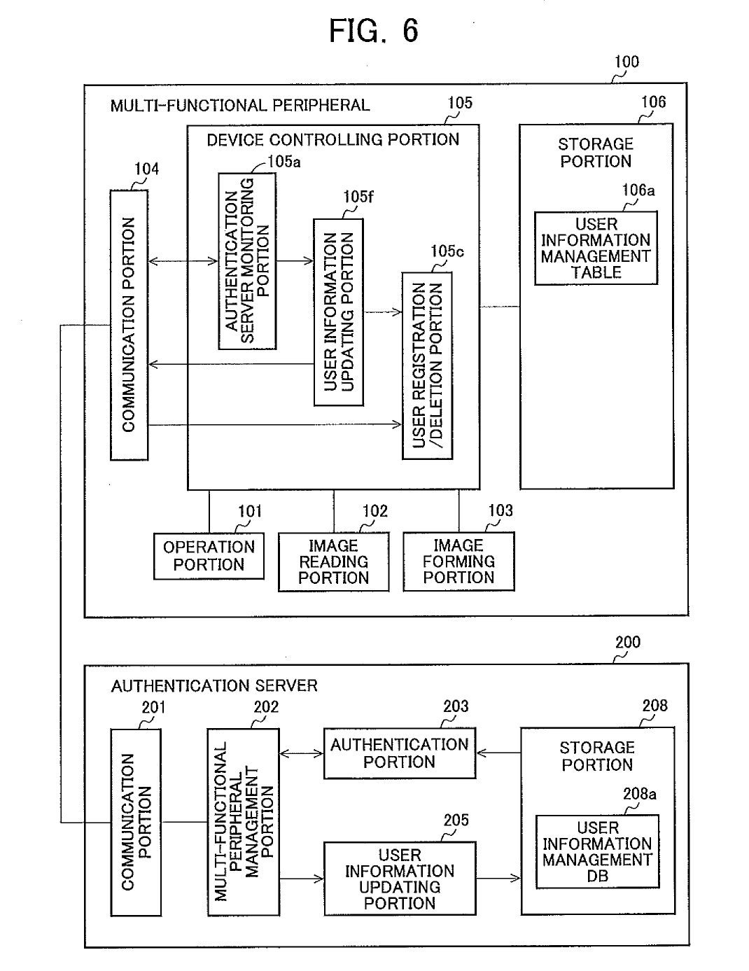

FIG. 6 is a block diagram showing a schematic configuration of the multi-functional peripheral control system according to the embodiment 3 of the present invention. In the diagram, the device controlling portion 105 includes the authentication server monitoring portion 105a, a user information updating portion 105f and the user registration/deletion portion 105c. Moreover, the storage portion 106 includes the user information management table 106a. The diagram includes the same components as those of the embodiment 1 and the embodiment 2, however, shows only differences.

<User Registration/Deletion Processing by Administrator Of Multi-Functional Peripheral 100>

The user information updating portion 105f reads authentication information (login name and password) and a registration instruction for a user who is designated by the operation portion 101 or the like, generates an identifier for the user (user ID), and registers in the user information management table 106a the user ID and the authentication information (login name and password) that are associated with each other.

Additionally, in the case of reading a deletion instruction, the user is deleted from the user information management table 106a.

Further, in the case of receiving a “connection signal” from the authentication server monitoring portion 105a, a user registration notification or a user deletion notification including the user authentication information (login name and password) is transmitted to the authentication server 200 via the communication portion 104.

<User Registration/Deletion Notification from Authentication Server 200>

The multi-functional peripheral 100, when receiving the user registration notification or the user deletion notification including the authentication information (login name and password) from the authentication server 200 via the communication portion 104, performs registration or deletion of a user notified from the user registration/deletion portion 105c to update the user information management table 106a.

<Configuration of Authentication Server 200 in Embodiment 3>

In FIG. 4, the authentication server 200 includes the communication portion 201, the multi-functional peripheral management portion 202, the authentication portion 203, a user information updating portion 205 and the storage portion 208. Furthermore, the storage portion 208 includes the user information management database 208a. The diagram includes the same components as those of the embodiment 1 and the embodiment 2, however, shows only differences.

<User Registration/Deletion by Administrator of Authentication Server 200>

The user information updating portion 205 inputs authentication information (login name and password) and a registration instruction for a user through an operation portion of the authentication server 200 or a client PC, generates an identifier for the input user (user ID), and registers in the user information management database 208a the user ID and the authentication information (login name and password) that are associated with each other.

Further, in the case of a deletion instruction, the user is deleted from the user information management database 208a.

Moreover, a user registration notification or a user deletion notification including the user authentication information (login name and password) is transmitted to all multi-functional peripherals 100 managed by the authentication server 200 via the communication portion 201.

<User Registration/Deletion Notified from Multi-Functional Peripheral 100>

The multi-functional peripheral management portion 202, when receiving the notification of user registration/deletion performed by the administrator in the multi-functional peripheral 100, performs registration or deletion of a notified user to update the user information management database 208a.

<Processing Procedure when User is Registered/Deleted by Administrator of Multi-Functional Peripheral>

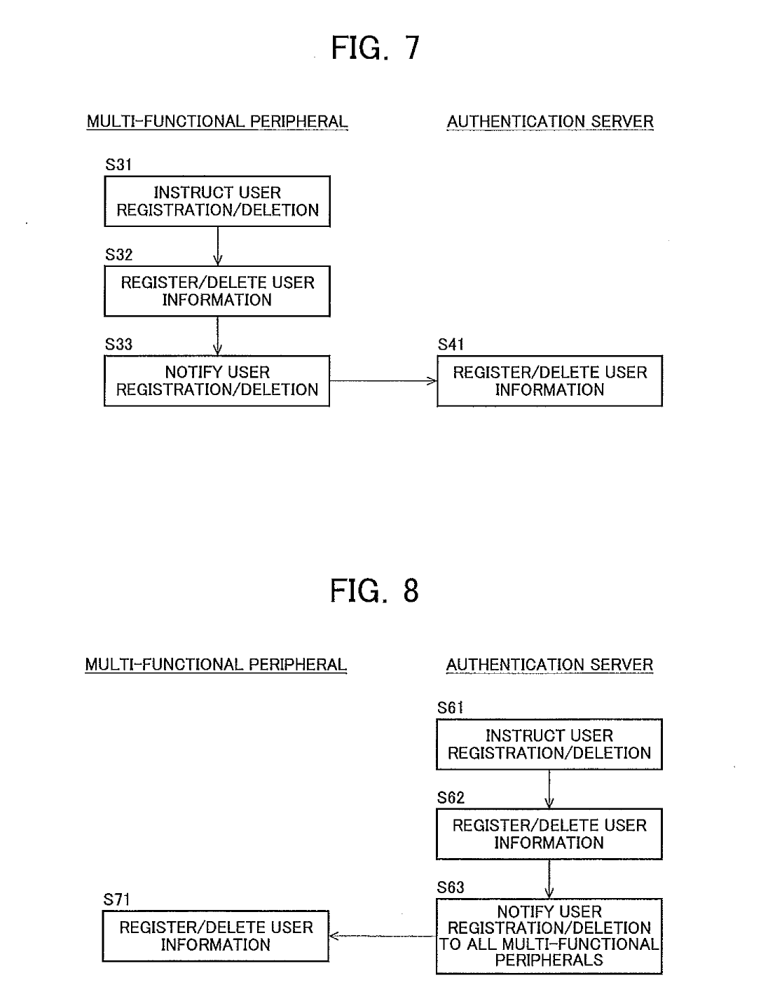

FIG. 7 is a flowchart describing a processing procedure in the case where a user is registered in/deleted from the multi-functional peripheral by an administrator when the multi-functional peripheral is in a connected state to the authentication server.

When the administrator inputs authentication information (login name and password) and a registration instruction or a deletion instruction for a user by the operation portion 101 of the multi-functional peripheral 100 (step S31), the user is registered in or deleted from the user information management table 106a (step S32), and a user registration notification or a user deletion notification is transmitted to the authentication server 200 (step S33).

The authentication server 200, when receiving the user registration notification or the user deletion notification from the multi-functional peripheral 100, registers or deletes the notified user in/from the user information management database 208a (step S41).

This allows the authentication server 200 and the multi-functional peripheral 100 to have the same content of user information registered/deleted in the multi-functional peripheral 100 by the administrator.

<Processing Procedure when User is Registered/Deleted by Administrator of Authentication Server 200>

FIG. 8 is a flowchart describing a processing procedure in the case where a user is registered in/deleted from the authentication server 200 by an administrator when the multi-functional peripheral is in a connected state to the authentication server.

When the administrator inputs user authentication information (login name and password) to be registered or deleted for the authentication server 200 (step S61), the user is registered in or deleted from the user information management database 208a (step S62), and a user registration notification or a user deletion notification of the user is transmitted to all multi-functional peripherals 100 managed by the authentication server 200 (step S63).

When the multi-functional peripheral 100 receives the user registration notification or the user deletion notification from the authentication server 200, the notified user is registered in or deleted from the user information management table 106a (step S71).

Note that, in the user information management table 106a of the above-described multi-functional peripheral 100, when considering memory capacity and the like, it is considered that the number of registration of users is within a predetermined number.

Therefore, in the case where the number of registration of users exceeds the predetermined number, a user determined based on any of the following rules ((a) to (d)) is automatically deleted from the user information management table 106a and a new user is thereafter registered.

(a) A user whose last use time is the oldest is deleted.

A termination time when the latest job is completed is recorded in the user information management database 208a for each user (see FIG. 2A), the user information management table 106a is updated every time external authentication is successfully performed, and a user whose last use time is the oldest is deleted in the case of excess of the number of registrations each time a new user is registered in the user information management table 106a.

Having an old last use time means that a user has not used for long periods of time, and it is therefore possible to minimize the effect when deleting.

(b) A user who has the smallest number of times of login (number of use of the multi-functional peripheral) is deleted.

The number of times of using the multi-functional peripheral 100 (number of times of login) is recorded in the user information management database 208a for each user (see FIG. 2A), the user information management table 106a is updated each time external authentication is successfully performed, and a user who has the smallest number of times of login is deleted in the case of excess of the number of registrations each time a new user is registered in the user information management table 106a.

For example, a person A who works at a head office has output printed materials from a multi-functional peripheral every day, however, has just come back to the office from a three-month long business trip, therefore, in the case of focusing only on the last use time, he has the oldest one.

On the other hand, a person B who works at a branch office noticed that a document has not been printed at the time of visiting a head office, thus used a multi-functional peripheral of the head office, however, has no plan to use the multi-functional peripheral in future.

In the case of such circumstances, a user whose registration is desired to be deleted is the person B, however, since the person A may be deleted if focusing only on the last use time, a user who has the smallest number of times of login is deleted so that it is possible to delete a user who has temporarily used.

(c) A user who meets a condition of the above-described (a) or (b) is deleted from among users whose registration classification is “automatic”.

In the user information management table 106a, “manual” is stored as a registration classification when an administrator registers a user, or “automatic” is recorded as a registration classification when a user is registered in external authentication (see FIG. 2A).

Every time a new user is registered in the user information management table 106a, excess of the number of registrations is determined, and a user who meets a condition of the above-described (a) or (b) is determined to be deleted from among users whose registration classification is “automatic” at the time of exceeding.

For example, there is a case where a user such as an executive of company who has to be able to use a multi-functional peripheral all the time is manually registered inside the multi-functional peripheral as a user so as to be able to use even when it is impossible to connect to an authentication server.

Since it interferes with business if the user who is manually registered purposely by the administrator in this manner is automatically deleted, a user who is automatically deleted is limited to a user who is automatically registered inside the multi-functional peripheral so that an important user is able to use the multi-functional peripheral all the time.

(d) In the case where a plurality of users who correspond to the above-described condition of (a), (b) or (c) are detected, a user whose user ID number is the smallest is deleted.

This makes it possible to prevent from becoming an unintended situation where a plurality of users may be deleted even though there is one user who has to be deleted.

Further, the present invention is not limited to the above-described embodiments, and various changes and modifications can certainly be made without departing from the scope of the present invention.

For example, it is possible to configure so that the above-described embodiments 1 to 3 are appropriately combined.

According to the present invention, an update content of user information that is used for authentication processing in the authentication server is also reflected in the alternate authentication portion, and it is thus possible to perform appropriate authentication processing similarly to the authentication server even when authentication is performed at the alternate authentication portion.

1. A multi-functional peripheral control system composed of an authentication server having a user information management database for storing authentication information corresponding to each user, and that performs user authentication processing with reference to the user information management database, and one or more multi-functional peripherals managed by the authentication server, the multi-functional peripheral having a user information management table for storing authentication information corresponding to a user, when being possible to connect to the authentication server, transmitting user information to the authentication server to perform authentication processing, and when being impossible to connect to the authentication server, performing alternate authentication with reference to the user information management table, wherein
the multi-functional peripheral includes a user deletion portion for deleting user information that is not permitted to be authenticated by the authentication server from the user information management table.

2. The multi-functional peripheral control system as defined in claim 1, wherein
the multi-functional peripheral, in the case of performing the alternate authentication, when connection to an authentication server is restored, transmits a job processing result completed by the alternate authentication to the authentication server, and when receiving a notification that user authentication information according to the job processing result is not permitted to be authenticated by the authentication server, deletes the user from the user information management table.

3. The multi-functional peripheral control system as defined in claim 1 or 2, wherein
when registration/deletion of a user of a user information management table of the multi-functional peripheral or a user information management database of the authentication server is performed by an administrator, a notification of registration/deletion of the user is transmitted from the multi-functional peripheral to the authentication server or from the authentication server to each multi-functional peripheral, and registration/deletion of the user is reflected in the user information management table or the user information management database to register/delete the user.

4. The multi-functional peripheral control system as defined in claim 1 or 2, wherein
when the number of users to be registered in the user information management table exceeds a predetermined number, the multi-functional peripheral deletes a user whose date and time of using the multi-functional peripheral is the oldest from the user information management table.

5. The multi-functional peripheral control system as defined in claim 1 or 2, wherein
when the number of users to be registered in the user information management table exceeds a predetermined number, the multi-functional peripheral deletes a user whose number of using the multi-functional peripheral is the smallest from the user information management table.

6. The multi-functional peripheral control system as defined in claim 4, wherein
in the multi-functional peripheral, the user to be deleted is a user registered in the user information management table when authenticated by the authentication server.

7. The multi-functional peripheral control system as defined in claim 4, wherein
the multi-functional peripheral, when there are a plurality of users to be deleted, deletes a user whose user identification number is the smallest.

8. A multi-functional peripheral having a user information management table for storing authentication information corresponding to a user,
when it is possible to connect to an authentication server that performs user authentication processing with reference to a user information management database for storing authentication information corresponding to each user, transmitting user information to the authentication server to perform authentication processing, and when it is impossible to connect to the authentication server, performing alternate authentication with reference to the user information management table, comprising:
a user deletion portion for deleting user information that is not permitted to be authenticated by the authentication server from the user information management table.

9. The multi-functional peripheral as defined in claim 8, wherein
in the case where the alternate authentication is performed, when connection to an authentication server is restored, a job processing result completed by the alternate authentication is transmitted to the authentication server, and when a notification that user authentication information according to the job processing result is not permitted to be authenticated by the authentication server is received, the user is deleted from the user information management table.

10. The multi-functional peripheral as defined in claim 8 or 9, wherein
when registration/deletion of a user of a user information management table of the multi-functional peripheral is performed by an administrator, a notification of registration/deletion of the user is transmitted from the multi-functional peripheral to the authentication server, and registration/deletion of the user is reflected in the user information management database to register/delete the user.

11. The multi-functional peripheral as defined in claim 8 or 9, wherein
when the number of users to be registered in the user information management table exceeds a predetermined number, a user whose date and time of using the multi-functional peripheral is the oldest is deleted from the user information management table.

12. The multi-functional peripheral as defined in claim 8 or 9, wherein
when the number of users to be registered in the user information management table exceeds a predetermined number, a user whose number of using the multi-functional peripheral is the smallest is deleted from the user information management table.

13. The multi-functional peripheral as defined in claim 10, wherein
the user to be deleted is a user registered in the user information management table when authenticated by the authentication server.

14. The multi-functional peripheral as defined in claim 11, wherein
when there are a plurality of users to be deleted, a user whose user identification number is the smallest is deleted.
